(19) United States
(12) Patent Application Publication
(10) Pub. No.: US 2014/0050197 A1
(43) Pub. Date: Feb. 20, 2014

(54) Method for Providing Information in a Cellular Wireless Communication System

(71) Applicants: Peter Legg, Kista (SE); Henrik Olofsson, Kista (SE)

(72) Inventors: Peter Legg, Kista (SE); Henrik Olofsson, Kista (SE)

(73) Assignee: Huawei Technologies Co., Ltd., Shenzhen (CN)

(21) Appl. No.: 13/981,299

(22) PCT Filed: Aug. 11, 2010
(86) PCT No.: PCT/CN2010/075869

§ 371 Date: Nov. 5, 2013

(51) Int. Cl. H04W 36/00

(52) U.S. Cl. CPC H04W 36/0072
USPC 370/331

(57) ABSTRACT

The present invention relates to a method for providing information in a cellular wireless communication system, wherein each cell in said cellular wireless communication system is served by a base station, and said cellular wireless communication system employs a procedure in which a mobile station suffering from a radio link failure (RLF), when being connected to a cell, may attempt to re-establish a connection in another cell, comprising the steps of: detecting a radio link failure (RLF) for said mobile station while connected to a first cell; requesting a radio resource control (RRC) re-establishment for said mobile station in a second cell after said radio link failure (RLF); and providing information, whether said radio resource control (RRC) re-establishment for said mobile station was successful or not, to said first cell and/or to a third cell, wherein said third cell is the cell to which said mobile station was connected before said first cell. Furthermore, the invention also relates to a method in a base station, a computer program, a computer program product, and a base station device.

### TECHNICAL FIELD

The present invention relates to a method for providing information in a cellular wireless communication system, or more particularly to a method according to the preamble of claim 1. Furthermore, the invention also relates to a method in a base station, a computer program, a computer program product, and a base station device.

### BACKGROUND OF THE INVENTION

Normally a mobile station (MS) in active mode in a cellular wireless communication system is handed over from one cell to the next as it moves through the system, and data can be transmitted and received without significant interruptions due to these handovers.

A handover (HO) procedure can consist of many steps. In many cellular wireless communication systems a HO is: 1) network controlled, i.e. the MS is commanded by the network when to connect to another cell; 2) prepared, i.e. the target cell to which the MS is moving to is prepared; and 3) MS assisted, i.e. the MS provides measurement reports before HO to the serving cell to assist the decision to do HO preparation of target cell(s), and when to leave the serving cell/connect to the target cell.

In the context of HO, the serving cell before HO is often referred to as the source cell. After successful HO the target cell becomes the new serving cell. In Long Term Evolution (LTE) the HO is a “hard handover”, which means that the UE radio link is switched from one (source) cell to another (target) cell. In Universal Mobile Telecommunications System (UMTS) hard handovers are used exclusively for Time Division Duplex (TDD) mode, but may also be used for Frequency Division Duplex (FDD) mode.

In the following discourse, the focus is on the intra frequency LTE HO procedure, but the procedures are similar for the LTE inter Radio Access Technology (RAT) and LTE inter frequency HO procedures. The intra E-UTRAN in RRC_CONNECTED state is a User Equipment (UE) assisted network controlled HO, with HO preparation signalling in E-UTRAN.

A HO is initially triggered by a measurement report sent from a UE to a serving eNB (E-UTRAN NodeB). The serving eNB configures how the UE shall take measurements, and under what conditions a measurement report shall be triggered and sent to the eNB.

To assist mobility control decisions, the UE can measure several different cells and report the results to the network. Different networks and network deployments can have different detailed behaviour, but in most systems it is natural to trigger HO when signal reception from a target cell is better than from a source cell.

For the case of intra-frequency HO in a reuse-one system (i.e. in a system where the source cell and the target cell uses exactly the same frequency resources) there are strong interference management benefits in (always) keeping the UE connected to the cell with the best signal strength. In the measurement report, the UE includes the reason for the trigger of a HO, e.g. target cell signal stronger than serving cell signal, and measurements of a Reference Signal Received Power (RSRP) or Reference Signal Received Quality (RSRQ) of the serving cell and several neighbour cells including the target cell. To reduce ping-pong effects where a UE is handed over repeatedly between two cells a HO offset is often added to the HO trigger condition: target cell signal should be better than the serving cell signal by an offset, wherein the offset value >0 dB.

When a serving eNB receives a measurement report from a UE and if the eNB wishes to HO the UE to another cell, the eNB performs a HO preparation to that cell. HO preparation involves a signalling exchange between one (serving) eNB and another (target) eNB. The source cell requests the HO (Handover Request) and passes over UE context information; and the target cell decides if it can admit the UE (Call Admission Control) and either accepts or rejects the HO. In an acceptance message (Handover Request Ack), the target cell includes parameters required by the UE to allow it to communicate to the target cell—these parameters being grouped into a transparent container. The source cell may prepare multiple cells for HO.

Following a successful preparation, the HO execution takes place. The source cell issues a HO Command to the UE—this is the RRCConnectionReconfiguration message and carries the transparent container. If, and when, the UE receives this message correctly the UE synchronises to the new target cell and sends a synchronisation message on the Random Access Channel (RACH). The target cell then issues an allocation to the UE so that the UE can send a HO confirmation message to the target cell (RRCConnectionReconfiguration-Complete message).

In the final steps (Handover Completion), which do not involve the UE, the source eNB (serving the source cell) is able to forward data (un-acknowledged downlink packets) to the target eNB (serving the source cell), and the S1-U interface from the Serving Gateway (S-GW) must be switched from the source to the target cell (“path switch”). Finally, if the HO is successful, the target eNB issues a UE Context Release message to the source eNB.

However, it is possible for a HO to fail at different points because of a Radio Link Failure (RLF) or a failure by the RACH. A RACH failure during a HO is called “Handover Failure” in 3GPP TS36.331, but for the remainder of this disclosure the term HO failure is used to include both RLF and RACH failures.

After a HO failure, the UE attempts a RRC re-establishment which is described in specifications 3GPP TS36.300 and 3GPP TS36.331. The UE firstly tries to find the strongest cell that it can detect (“cell selection”), and then the UE sends a RRCConnection-ReestablishmentRequest to the cell that it has selected. If this selected cell has prior knowledge of the UE and details regarding the UE connection (e.g. security parameters, this is called the “UE Context”) then the cell can send a RRCConnectionReestablishment and the re-establishment will succeed which means that the UE remains in Radio Resource Control (RRC) connected state.

If however the UE context is lacking the re-establishment request is rejected and the UE drops to RRC idle state, which results in further delay before the UE can transit to RRC connected state and recommence any data communication. The “UE Context” may be passed to a cell during the HO procedure or at some other point in time. This transfer is called HO Preparation. Note also that the RRCConnectionReestablishmentRequest carries three fields, the Cell Radio Network Temporary Identifier (C-RNTI) of the UE in the serving cell where failure occurred, the Physical Cell Identity (PCI) of this cell, and the shortMAC-I calculated using the Identity (ID) of the re-establishment cell.

The procedure for a successful RRC connection re-establishment is shown in FIG. 2 and for an un-successful RRC connection re-establishment in FIG. 3. Further, an example of too late HO (see below) followed by a successful RRC connection re-establishment is shown in FIG. 4 and too late HO followed by an un-successful RRC connection re-establishment is shown in FIG. 5.

The hard HO in the Universal Mobile Telecommunications System (UMTS) is very similar in many respects to the above description—i.e. also being UE assisted but network controlled, which means that the UE is configured to send triggered measurement reports but the network decides when to execute the HO; exploits preparation (using Radio Link Setup procedure); is “backward” HO, which means that the source cell sends the HO command to the UE and the UE replies to the target cell; and is completed by inter-node signalling.

Furthermore, RLF is described in specifications 3GPP TS36.300 and 3GPP TS36.331. One form of RLF is driven by out-of-sync detection by Layer 1. A radio problem detection procedure is started when a UE receives a certain number of consecutive “out-of-sync” indications from lower layers. The number of consecutive indications is specified by the threshold N310. When this happens, the UE starts a timer T310. In case the UE receives a certain (N311) consecutive “in-sync” indications from lower layers while T310 is running, the UE shall stop the timer and return to normal operation. If T310 expires then a RLF is recognised to have occurred (“declared”) by the UE.

Following the declaration of a RLF, the UE attempts cell selection. If the UE manages to find a cell to connect to within the cell selection phase, the UE will attempt to re-establish RRC to this cell. If, on the other hand, the UE does not find a cell within the cell selection phase (T311), the UE goes back to idle mode and may start looking for cells on other RATs, examples of which are LTE, UMTS, WiMaX and GSM EDGE Radio Access Network (GERAN).

A RLF can also be declared by the Radio Link Control (RLC) layer of the UE when a maximum number of transmissions have been reached for transmission of an uplink RRC signalling packet, but the packet has still not been delivered successfully. Additionally, if the random access during the HO fails (T304 timeout) the UE behaves as if a RLF had occurred. In the present discourse the term RLF relates to any of the above mentioned events.

Moreover, a RLF report was introduced in 3GPP Rel-9 to enable an eNB receiving a RLF indication message to distinguish between Mobility Robustness Optimisation (MRO) related problems and coverage problems. This was done by including a set of neighbour cell measurements indicating the signal strength at the time of failure. With the help of this, the eNB is able to see if there is an alternative neighbour cell that might have been used, or if there is no neighbour detected in the case of a coverage hole.

The RLF report carries information about:
Serving cell RSRP, and optionally RSRQ;
Neighbours cell RSRP/RSRQ; and
May also indicate the strength of detected inter-RAT neighbour cells.

In Rel-9, if a RLF during a HO is followed by a successful RRC Re-establishment, it is possible to include a RLF Report in a RLF INDICATION message that is sent from a eNB where re-establishment takes place to a eNB that was serving the UE at the point of RLF. The capability of the UE to provide the RLF Report is indicated by a flag in the RCConnectionReestablishmentComplete message. The RLF Report is then provided to the eNB where re-establishment took place using the UE Information procedure.

Furthermore, in 3GPP there has been considerable study into Self-Organising Networks (SON) for LTE. One part of this is the Handover Parameter Optimisation also known as the above mentioned MRO which is aiming at optimising mobility parameters. It has not been specified which HO parameters shall be optimised, but examples include the HO hysteresis (also called offset) and the Time to Trigger (TTT) parameters. The aims of the optimisation are to reduce HO failures whilst at the same time not having more HOs than are necessary. The MRO functionality is distributed in the Evolved-UTRAN (E-UTRAN), i.e. every eNB has its own MRO optimisation function. To assist optimisation, signalling has also been defined between eNBs to help identify HO failure events.

The following is the text describing the use-case of Handover Parameter Optimisation also known as MRO in section 22.5 of specification 3GPP TS36.300, 9.2.0:
One of the functions of Mobility Robustness Optimization MRO is to detect RLFs that occur due to Too Early or Too Late Handovers, or Handover to Wrong Cell. This detection mechanism is carried out through the following procedures:
   [Too Late HO] If the UE attempts to re-establish the radio link at eNB B after a RLF at eNB A then eNB B may report this RLF event to eNB A by means of the RLF Indication Procedure.
   [Too Early HO] eNB B may send a HANDOVER REPORT message indicating a Too Early HO event to eNB A when eNB B receives an RLF Indication from eNB A and if eNB B has sent the UE Context Release message to eNB A related to the completion of an incoming HO for the same UE within the last Tstore_UE_cntxt seconds.
[HO to Wrong Cell] eNB B may send a HANDOVER REPORT message indicating a HO To Wrong Cell event to eNB A when eNB B receives an RLF Indication from eNB C, and if eNB B has sent the UE Context Release message to eNB A related to the completion of an incoming HO for the same UE within the last Tstore_UE_cntxt seconds. The indication may also be sent if eNB B and eNB C are the same and the RLF report is internal to this eNB.
The detection of the above events is enabled by the RLF Indication and Handover Report procedures.
The RLF Indication procedure may be initiated after a UE attempts to re-establish the radio link at eNB B after a RLF at eNB A. The RLF INDICATION message sent from eNB B to eNB A shall contain the following information elements:
   Failure Cell ID: PCI of the cell in which the RLF occurred;
   Reestablishment Cell ID: ECGI of the cell where RL re-establishment attempt is made;
   C-RNTI: C-RNTI of the UE in the cell where RLF occurred.
   shortMAC-I (optionally): the 16 least significant bits of the MAC-I calculated using the security configuration of the source cell and the re-establishment cell identity.
eNB B may initiate RLF Indication towards multiple eNBs if they control cells which use the PCI signalled by the UE during the re-establishment procedure. The eNB A selects the UE context that matches the received Failure cell PCI and C-RNTI, and, if available, uses the shortMAC-I to confirm this identification, by calculating the shortMAC-I and comparing it to the received IE.
The Handover Report procedure is used in the case of recently completed handovers, when an RLF occurs in the target cell (in eNB B) shortly after it sent the UE Context Release message to the source eNB A. The HANDOVER REPORT message contains the following information:
   Type of detected handover problem (Too Early HO, HO to Wrong Cell)
   ECGI of source and target cells in the handover
   ECGI of the re-establishment cell (in the case of HO to Wrong Cell)
   Handover cause (signalled by the source during handover preparation)

Further, according to specification 3GPP TS32.522, the MRO is expected to: a) meet a specified HO failure rate target, and b) minimize the number of HO events whilst meeting this target value. Studies have though shown that HO failure rate reduction and HO count reduction are contradictory requirements; if the failure rate is reduced the HO count increases, and vice versa.

Requirements a) and b) above reflect the fact that meeting the failure rate is of higher priority. A typical failure rate target would be 1%, and the MRO should not engineer a failure rate below the target because this will cause more HO than if the failure rate was equal to the target value. Looking more closely at requirement a), 3GPP defined 3 possible targets in specification 3GPP TS32.522 which may be used together or in part. These targets are presented in table 1 below.

TABLE 1

| Target Name | Definition | Legal Values |
|---|---|---|
| Rate of failure | (the number of failure events related to HO)/(the total | Integer |
| related to HO | number of HO events). | [0 . . . 100] in unit |
| | | percentage |
| Rate of failure | (the number of failure events related to HO without RRC | Integer |
| related to HO | state transition)/(the total number of HO events). | [0 . . . 100] in unit |
| without RRC | RRC state transition means from RRC_CONNECTED to | percentage |
| state transition | RRC_IDLE, refer to specification TS 36.331. | |
| Rate of failure | (the number of failure events related to HO with RRC | Integer |
| related to HO | state transition)/(the total number of HO events). | [0 . . . 100] in unit |
| with RRC state | RRC state transition means from RRC_CONNECTED to | percentage |
| transition | RRC_IDLE, refer to specification TS 36.331. | |

There is a need for a source eNB to judge whether a RLF related to a HO failure for a UE was followed by a successful RRC Re-establishment. In other words, whether the UE was able to stay in RRC Connected state or a transition to RRC Idle state took place after the RLF. This knowledge is required for mainly two reasons:
So that the source eNB may take measurements, e.g. Performance Measurements (PM) to be passed over the Itf-N interface (between the eNB and OAM) in support of the MRO targets above. These measurements should be collected at the source eNB since the measurements for HO are normally defined for outgoing HOs; and
To allow the optimization function at the source eNB to optimize against targets that specify the HO failure rate with/without RRC state change. HO failures are addressed at the source eNB since this is able to adjust HO parameters that can influence the performance of future HO failures. The source eNB can make changes to improve the likelihood of a HO failure being followed by a successful re-establishment for HO failure cases in which the HO failure occurs during the HO from the source cell. The eNB does this by preparing cells prior to the HO failure. For example, instead of just preparing the cell which is the HO target, the source eNB can prepare additional cells in the neighbourhood—if failure occurs during the HO and if the UE attempts re-establishment to one of these additional prepared cells it should succeed. Failures which occur immediately after a HO are not treatable in this way—only the target cell can influence the preparedness of neighbour cells here. However, the source cell can attempt to reduce the frequency of the HO failure event in these cases, thus improving the HO failure rate with RRC state change and likewise without RRC state change.

### SUMMARY OF THE INVENTION

An object of the present invention is to provide a method for providing information which may be used for tuning/improving mobility parameters and/or making performance measurements. Another object of the invention is to provide a method which makes a small impact on existing system regarding signalling, protocols, etc. A yet another object of the invention is to provide an alternative method for providing information in a cellular wireless communication system.

According to one aspect of the invention, the objects are achieved with a method for providing information in a cellular wireless communication system, wherein each cell in said cellular wireless communication system is served by a base station, and said cellular wireless communication system employs a procedure in which a mobile station suffering from a radio link failure (RLF), when being connected to a cell, may attempt to re-establish a connection in another cell, comprising the steps of:
detecting a radio link failure (RLF) for said mobile station while connected to a first cell;
requesting a radio resource control (RRC) re-establishment for said mobile station in a second cell after said radio link failure (RLF); and
providing information, whether said radio resource control (RRC) re-establishment for said mobile station was successful or not, to said first cell and/or to a third cell, wherein said third cell is the cell to which said mobile station was connected before said first cell.

Embodiments of the method in a communication system above are disclosed in the dependent claims 2-16.

According to another aspect of the invention, the objects are also achieved with a method in a base station for providing information in a cellular wireless communication system, wherein each cell in said cellular wireless communication system is served by a base station, and said cellular wireless communication system employs a procedure in which a mobile station suffering from a radio link failure (RLF), when being connected to a cell, may attempt to re-establish a connection in another cell, comprising the steps of:
receiving a radio resource control (RRC) re-establishment request from said mobile station;
registering a radio link failure (RLF) for said mobile station while connected to a first cell; and
providing information, whether said radio resource control (RRC) re-establishment for said mobile station was successful or not, to said first cell and/or to a third cell, wherein said third cell is the cell to which said mobile station was connected before said first cell.

The method in a base station above involves according to an embodiment: transmitting said information to a first base station serving said first cell or to a third base station serving said third cell directly or via one or more X2 and/or S1 interfaces over one or more other base stations in said cellular wireless communication system.

The invention also relates to a computer program and a computer program product when run in a computer causes the computer to execute the method in a base station described above.

According to yet another aspect of the invention, the objects are also achieved with a base station device for providing information in a cellular wireless communication system, wherein each cell in said cellular wireless communication system is arranged to be served by a base station, and said cellular wireless communication system employs a procedure in which a mobile station suffering from a radio link failure (RLF), when being connected to a cell, may attempt to re-establish a connection in another cell, being configured to:
receive a radio resource control (RRC) re-establishment request from said mobile station;
register a radio link failure (RLF) for said mobile station while connected to a first cell; and
provide information, whether said radio resource control (RRC) re-establishment for said mobile station was successful or not, to said first cell and/or to a third cell, wherein said third cell is the cell to which said mobile station was connected before said first cell.

The base station device according to the invention may also be arranged according to the different embodiment of the methods above.

The present invention enables the collection of data independent on the capability of the mobile station. The only thing that is required is that the mobile station is capable of performing RRC re-establishment. The information regarding the outcome of RRC re-establishment request for a mobile station is reliably provided to a base station, according to the invention, to be used e.g. for tuning mobility parameters and/or providing one or more performance measurements. Another advantage with the present invention is that it captures the actual success rate by feeding back the actual outcome of the re-establishment attempt.

Other advantages and applications of the present invention will be apparent from the following disclosure.

### BRIEF DESCRIPTION OF THE DRAWINGS

The appended drawings are intended to clarify and explain different embodiments of the present invention in which:

FIG. 1 shows a typical cell scenario with cell measurement;

FIG. 2 shows a successful RRC connection re-establishment;

FIG. 3 shows a failure RRC connection re-establishment;

FIG. 4 shows an example of a too late HO failure followed by a successful RRC re-establishment;

FIG. 5 shows an example of a too late HO failure followed by an unsuccessful RRC re-establishment; and

FIG. 6 shows a message sequence chart showing passing of re-establishment success flag.

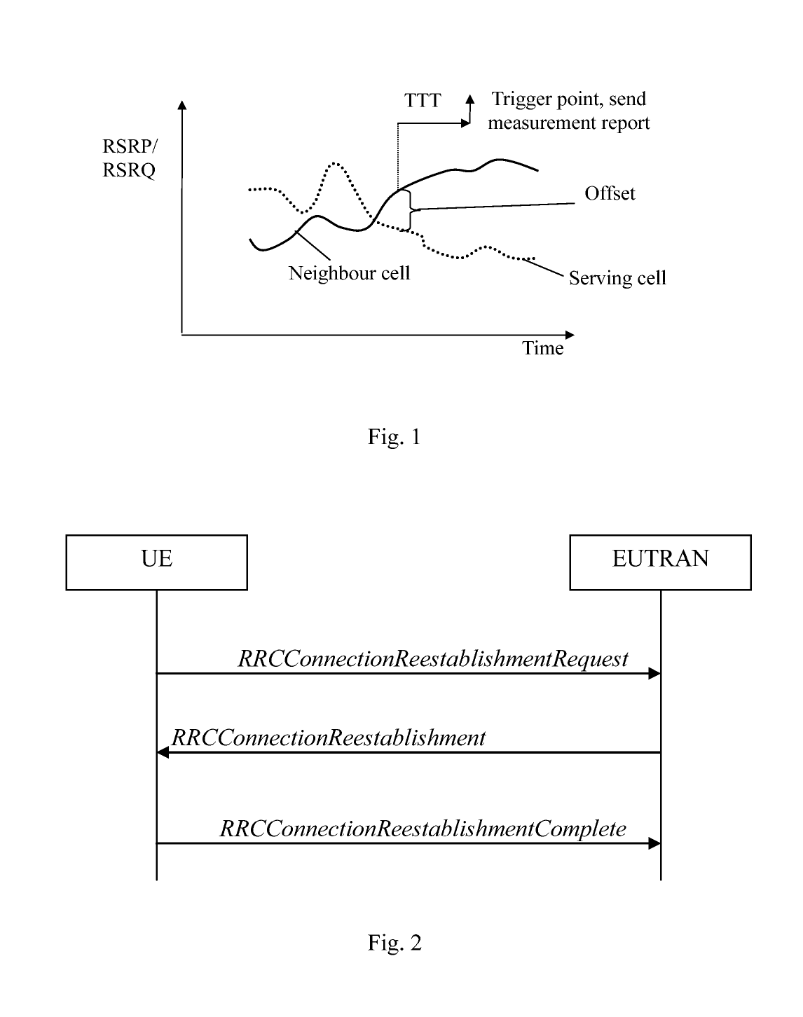

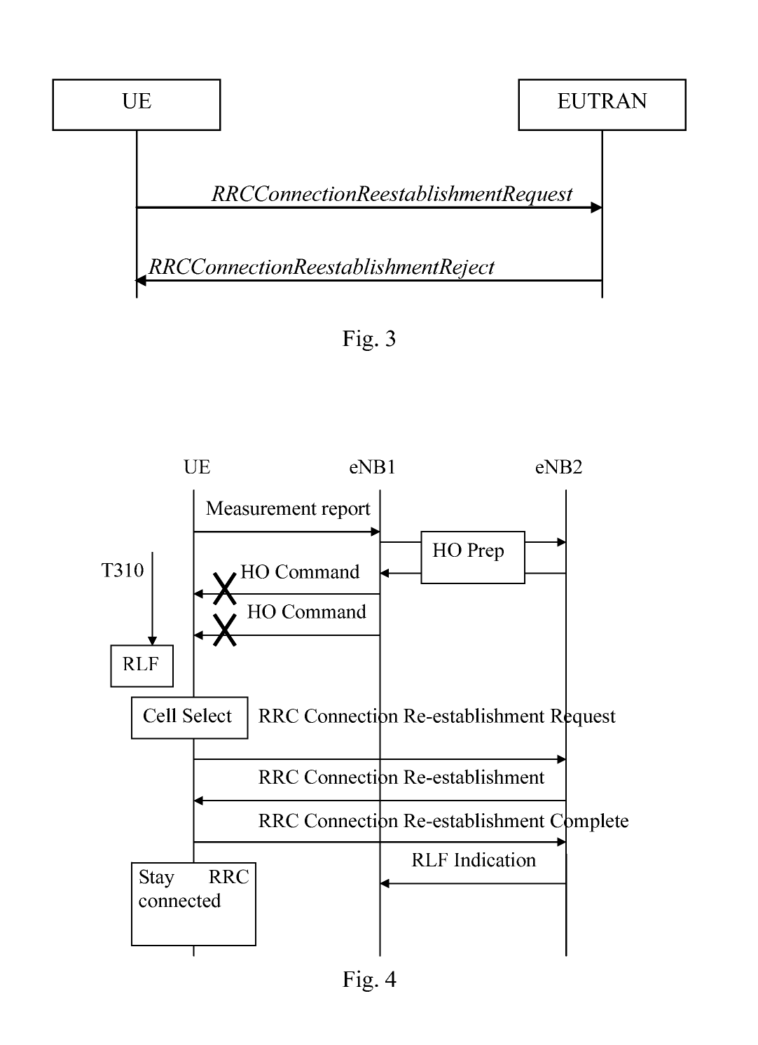

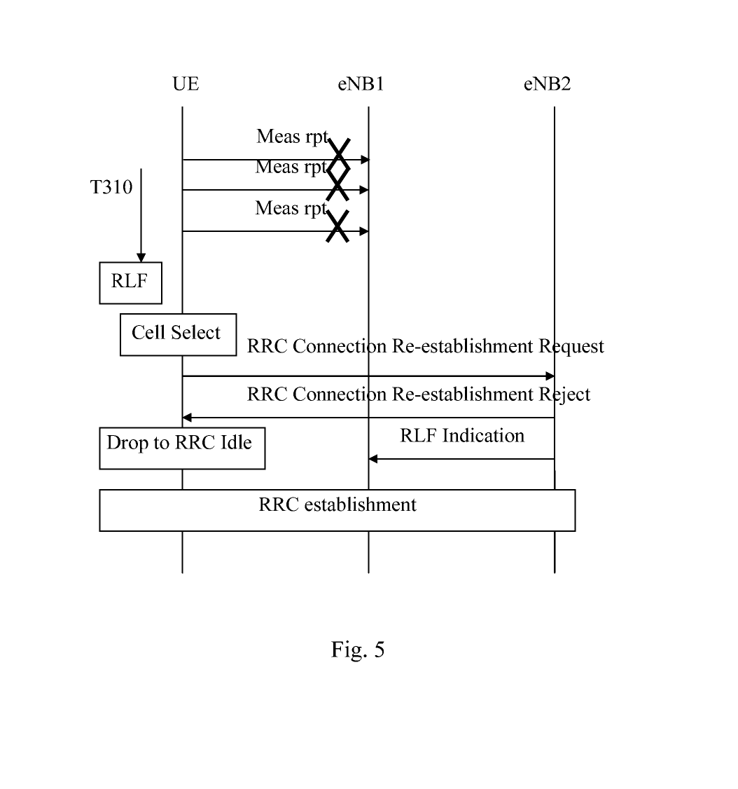

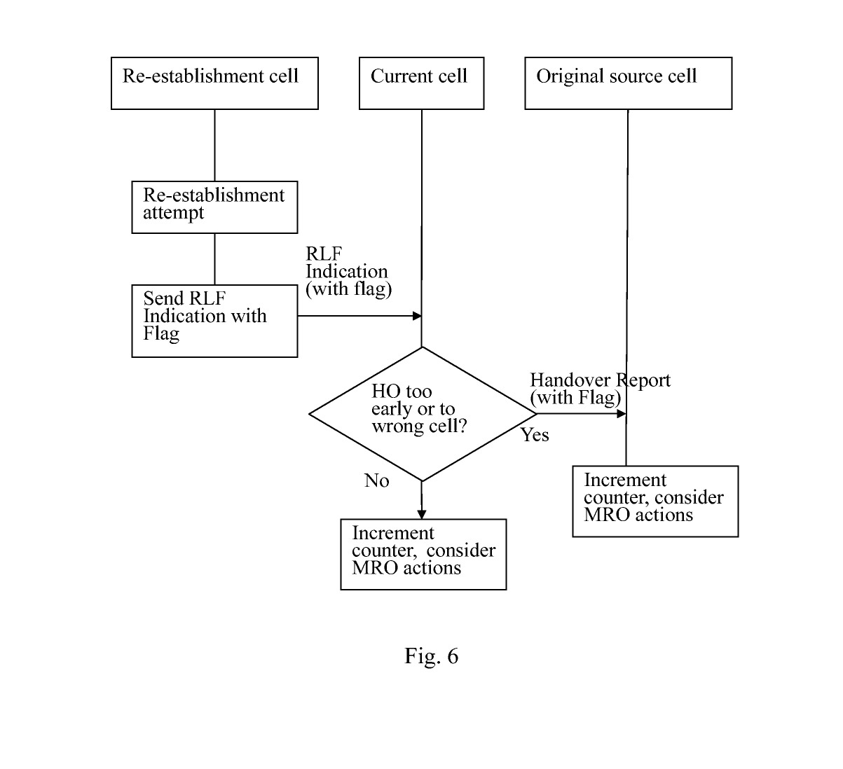

### DETAILED DESCRIPTION OF EMBODIMENTS OF THE INVENTION

The invention enables a source eNB to determine whether a RRC re-establishment attempt following a radio link failure (RLF) was successful or not. Using this knowledge the source eNB can among other things: take measurements, such as PM to be passed over Itf-N, in support of the MRO targets Rate of failures related to HO without RRC state transition and Rate of failures related to HO with RRC state transition; and optimize against these failure targets.

The present invention achieves these and other goals by a method for providing information in a cellular wireless communication system. Preferably, each cell in the cellular wireless communication system is only served by one Base Station (BS), but the BS may serve more than one cell in the system.

The cellular wireless communication system further employs a HO procedure in which a MS suffering from a radio link failure (RLF), when being connected to a cell, may attempt to re-establish a connection in another cell. The method comprises the steps of: detecting a RLF for a MS while connected to a first cell; requesting a RRC re-establishment for the MS in a second cell after the RLF; and providing information, whether the RRC re-establishment for the MS was successful or not, to the first cell or to a third cell, wherein the third cell is the cell to which the MS was connected before the first cell.

In a preferred embodiment of the invention the step of providing information involves: transmitting the information in a RLF indication message to a first BS serving the first cell, or transmitting the information in a HO report message to a third BS serving the third cell.

According to another embodiment, the information is transmitted in a RLF indication message from the second cell to the first cell and in a HO report message from the first cell to the third cell.

According to yet another embodiment of the invention, the information whether the RRC re-establishment for the MS was successful or not is represented as a binary flag in a RLF indication message or in a HO report message. FIG. 6 shows an example of a message chart of an embodiment of the invention using a flag. Using a flag is a compact may of explicitly transmitting the information.

However, the inventor has also realised that the information may be represented by a presence or absence of a field in a RLF report or in RLF indication message; of presence or absence of a field in a RLF report or in a HO report message. Preferably, the field is an establishment cell identity (TD) field or a time from re-establishment to establishment field. Using existing fields is a compact and efficient way of implicitly transmitting the information

The information may also according to another embodiment of the invention be provided to the first cell and/or the third cell when a time period after a successful HO to the first cell is less than a threshold value T_{Max}.

In the case that the RRC re-establishment is requested in the second cell, the information is preferably transmitted by a second BS serving the second cell.

According to another embodiment of the invention the second and third cell is the same cell, which includes the case where there is a too early HO failure in which a RLF occurs shortly after a successful handover HO.

In the exemplary cases below different HO failure modes in a LTE system are captured and discussed in relation to the method according to the present invention, i.e. the impact of the present invention on a LTE system as specified by 3GPP for different cases. However, it should be understood that the present invention is not limited to the embodiments described above or to the following cases, but also relates to and incorporates all embodiments within the scope of the appended independent claims.

It should further be noted that the exemplary cases below only are only concerned with the RRC state transitions of HO failures that can be detected—if the RRCConnection-ReestablishmentRequest message of the re-establishment attempt following the failure is not received then the failure is not detectable.

Case 1
Type of HO failure: Too late HO—source and target cells belong to same eNB.
Failure mode: Failure occurs in the source cell.
HO failure detection method and signalling (if any) to the eNB handling the source cell: UE attempts re-establishment in the target cell—if the RRCConnectionReestablishmentRequest message is received correctly the HO failure can be conveyed to the source cell by means of internal eNB signalling.
Subsequent detection of whether UE passed to RRC idle state: Internal signalling from target cell tells source cell if re-establishment was successful.
Signalling impact on LTE system: No impact.

Case 2
Type of HO failure: Too late HO—source and target cells belong to different eNBs.
Failure mode: Failure occurs in the source cell.
HO failure detection method and signalling (if any) to source cell: UE attempts re-establishment in the target cell—if the RRCConnectionReestablishmentRequest message is received correctly the HO failure can be conveyed to the source cell (RLF INDICATION).
Subsequent detection of whether UE passed to RRC idle state: On reception of the RLF INDICATION, the source cell knows whether the target cell is prepared or not. If the target cell is not prepared the UE passes to RRC Idle. However, if the target cell is prepared it is possible for the re-establishment to fail if the RRCConnection-Reestablishment or RRCConnectionReestablishmentComplete cannot be delivered (even though the RRCConnectionReestablishmentRequest has been received).
Signalling impact on LTE system: To cover this case a 1-bit flag “Re-establishment Success” can be included in the RLF INDICATION message (in the case of a success the message must be sent after the re-establishment has concluded successfully).

Case 3
Type of HO failure: Too early HO—source and target cells belong to the same or different eNB.
Failure mode: Failure in the target during HO.
HO failure detection method and signalling (if any) to source cell: UE attempts re-establishment in the source cell—if the RRCConnectionReestablishmentRequest message is received correctly the HO failure can be detected at the source cell (the source cell has a UE context).
Subsequent detection of whether UE passed to RRC idle state: If the re-establishment in the source cell succeeds then this is counted as a HO failure without RRC state transition, else if it fails—RRCConnectionReestablishmentRequest is received but there are signalling failures in the procedure—it is counted as a HO failure with RRC state transition.
Signalling impact on LTE system: No impact.

Case 4
Type of HO failure: Too early HO—source and target cells belong to the same eNB
Failure mode: Failure in the target cell after HO
HO failure detection method and signalling (if any) to source cell: UE attempts re-establishment in the original source cell—if the RRCConnectionReestablishment-Request message is received the source cell indicates the re-establishment to the target cell using internal signalling similar to RLF Indication. The target cell can then recognize the occurrence of a too early HO and signal internally to the source cell.
Subsequent detection of whether UE passed to RRC idle state: If the re-establishment in the source cell succeeds then this is counted as a HO failure without RRC state transition, else if it fails because of failures in RRCConnectionReestablishment or RRCConnectionReestablishmentComplete, or because the source cell was not prepared, it is counted as a HO failure with RRC state transition.
Signalling impact on LTE system: No impact.

Case 5
Type of HO failure: Too early HO—source and target cells belong to different eNBs
Failure mode: Failure in the target cell after HO.
HO failure detection method and signalling (if any) to source cell: UE attempts re-establishment in the original source cell—if the RRCConnectionReestablishment-Request message is received the source cell indicates the re-establishment to the target cell (RLF INDICATION). The target cell can then recognize the occurrence of a too early HO and signal the source cell (HANDOVER REPORT).
Subsequent detection of whether UE passed to RRC idle state: The source cell knows whether the re-establishment is successful or not but it does not know what type of HO failure this is; only when it receives the HANDOVER REPORT message the source cell know the type. Furthermore, the HANDOVER REPORT does not identify the UE involved. Thus to increment the too early HO failure with RRC state transition and too early HO failure without RRC state transition counters correctly, the RLF INDICATION must include an indication of the re-establishment success, and this is relayed back to the source cell in the HANDOVER REPORT message in the case of a too early HO.
Signalling impact on LTE system: include a 1-bit flag “Re-establishment Success” in RLF INDICATION & HANDOVER REPORT.

Case 6
Type of HO failure: HO to wrong cell—source cell A and third cell C belong to different eNBs.
Failure mode: HO fails during execution and UE connects to a third cell C, not the intended target cell B.
HO failure detection method and signalling (if any) to source cell: UE attempts re-establishment in the third cell C—if the RRCConnectionReestablishmentRequest message is received the third cell sends a RLF INDICATION message to the source cell A.
Subsequent detection of whether UE passed to RRC idle state: On reception of the RLF INDICATION, the source cell A knows whether the third cell C is prepared or not. If the third cell C is not prepared the UE passes to RRC Idle. However, if the third cell C is prepared it is possible for the re-establishment to fail even though the RRC-ConnectionReestablishmentRequest message has been received—either one of the subsequent messages can fail.
Signalling impact on LTE system: To cover this case a 1-bit flag “Re-establishment Success” can be included in the RLF INDICATION message (in the case of a success the message must be sent after the re-establishment has concluded successfully). This is the same argument as case 2.

Case 7
Type of HO failure: HO to wrong cell—source cell A and third cell C belong to the same eNB
Failure mode: HO fails during execution and UE connects to a third cell C and not the intended target cell B.
HO failure detection method and signalling (if any) to source cell: This case follows case 6 above but when the source cell A and the third cell C share the same eNB, the RLF INDICATION message is not needed since internal signalling may be used instead.
Subsequent detection of whether UE passed to RRC idle state: No X2 signalling occurs.
Signalling impact on LTE system: No impact.

Case 8
Type of HO failure: HO to wrong cell—all cells belong to different eNBs.
Failure mode: HO succeeds but shortly afterwards RLF occurs and UE connects to a third cell C.
HO failure detection method and signalling (if any) to source cell: UE attempts re-establishment in the third cell C—if the RRCConnectionReestablishmentRequest message is received the third cell C sends a RLF INDICATION message to the target cell B. A HANDOVER REPORT message is sent from the target cell B to the source cell A to inform the source cell A of the outcome.
Subsequent detection of whether UE passed to RRC idle state: The third Cell A has no visibility of the re-establishment outcome to the third cell C, so a flag is needed in the HANDOVER REPORT. The target cell B knows if the third cell C was prepared but it cannot know in all circumstances whether the re-establishment to the third cell C was successful (for same reasoning as for case 6 above). Thus the RLF INDICATION and the HANDOVER REPORT should include a 1-bit flag “Re-establishment Success”.
Signalling impact on LTE system: the RLF INDICATION and the HANDOVER REPORT should include a 1-bit flag denoting a “Re-establishment Success”.

Case 9
Type of HO failure: HO to wrong cell—cells do not belong to different eNBs.
Failure mode: HO succeeds but shortly afterwards RLF occurs and the UE connects to a third cell C.
HO failure detection method and signalling (if any) to source cell: This follows case 8 above, but when the target cell B and the third cell C share the same eNB, the RLF INDICATION message is not needed as internal signalling may be used instead, and when the source cell A and the target cell B share the same eNB, the HANDOVER REPORT message is not needed since internal signalling may be used instead.
Subsequent detection of whether UE passed to RRC idle state: Same conclusions as case 8.

Signalling impact on LTE system: the RLF INDICATION (when required) and the HANDOVER REPORT (when required) should include a 1-bit flag denoting a “Re-establishment Success”.

According to another embodiment of the invention, instead of using explicit signalling in RLF indication messages, knowledge of the UE capability and an examination of the contents of the RLF indication message can be used. If a RLF report is present in the RLF indication message, and the UE is only capable of sending a RLF report when re-establishment succeeds (this is the Rel-9 3GPP behaviour), this means that the UE succeeded in RRC re-establishment. If the RLF report is not included in the RLF indication, and the UE is capable of sending the RLF report, it may be concluded that it is likely that the RRC re-establishment failed. This embodiment therefore uses implicit transfer of information.

According to another embodiment of the invention, it is possible to generate a RLF indication message with a RLF report if the re-establishment succeeds or if it fails. The recipient of a RLF indication with a RLF report according to this embodiment may identify some difference between the message in these two cases and thus identify whether the re-establishment succeeded or not. Indeed, a difference in the message contents could be used instead of an explicit flag. For example, in the failed re-establishment case the RLF report (or possibly in the main part of the RLF indication) could carry the ID of the cell where establishment took place, but this ID would be missing in the other case (since there has been no establishment). Another example could be the time period from re-establishment attempt to successful establishment (again this is not applicable to the successful case and would not be included).

According to yet another embodiment of the invention, an alternative to including explicit signalling of the outcome of a RRC re-establishment in the HO report, another possibility would be to collect statistics on a cell pair in the cell receiving the RLF indication message, and merge this statistics in OAM of the system. For example, assuming case 8 described above, eNB serving/handling cell B can store one counter for all “wrong cell” failure events between the cell pair (A, C) and one counter for all successful re-establishments associated for each of these failure events. However, in order to obtain full statistics for cell A, the OAM must collect statistics for all failure events involving cell A as source cell in all neighbouring cells. A person skilled in art can also see other possible combinations to retrieve the desired statistics, such as storing the number of rejected re-establishment together with the total number of failure events.

It should be understood that the cellular wireless communication system may be any relevant cellular system, such as LTE, UMTS, CDMA2000, WiMaX and GERAN. Accordingly, the BS may be any of a eNB, NodeB and BTS; and the MS any of UE, MS and SS; or any relevant MS or BS having the corresponding functions.

The invention also relates to a method in a BS comprising the steps of: receiving a RRC re-establishment request from a MS; registering a RLF for the MS while connected to a first cell;

and providing information, whether the RRC re-establishment for the MS was successful or not, to the first cell or to a third cell, wherein the third cell is the cell to which the MS was connected before the first cell. The information may be transmitted to a first base station serving the first cell and/or to a third base station serving the third cell directly or via one or more X2 and/or S1 interfaces over one or more other base stations.

Furthermore, as understood by the person skilled in the art, a method in a BS according to the present invention may be implemented in a computer program, having code means, which when run in a computer causes the computer to execute the steps of the method. The computer program is included in a computer readable medium of a computer program product. The computer readable medium may consist of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, the invention also relates a BS device being configured to: receive a RRC re-establishment request from a MS; register a RLF for the MS while connected to a first cell; and provide information, whether the RRC re-establishment for the MS was successful or not, to the first cell and/or to a third cell, wherein the third cell is the cell to which the MS was connected before the first cell.

1. A method for providing information in a cellular wireless communication system, wherein each cell in said cellular wireless communication system is served by a base station, and said cellular wireless communication system employs a procedure in which a mobile station suffering from a radio link failure (RLF), when being connected to a cell, may attempt to re-establish a connection in another cell, comprising:
detecting a radio link failure (RLF) for said mobile station while connected to a first cell;
requesting a radio resource control (RRC) re-establishment for said mobile station in a second cell after said radio link failure (RLF); and
providing information, whether said radio resource control (RRC) re-establishment for said mobile station was successful or not, to said first cell and/or to a third cell, and wherein said third cell is the cell to which said mobile station was connected before said first cell.

2. The method according to claim 1, wherein said step of providing information involves:
transmitting said information in a radio link failure (RLF) indication message to a first base station serving said first cell.

3. The method according to claim 1, wherein said step of providing information involves:
transmitting said information in a handover report message to a third base station serving said third cell.

4. The method according to claim 2, wherein said information is represented as a binary flag.

5. The method according to claim 2, wherein said information is represented by a presence or absence of a field in a radio link failure (RLF) report or in said radio link failure (RLF) indication message.

6. The method according to claim 3, wherein said information is represented by a presence or absence of a field in a radio link failure (RLF) report or in said handover report message.

7. The method according to claim 5, wherein said field is an establishment cell identity (ID) field or a time from re-establishment to establishment field.

8. The method according to claim 1, wherein said information is transmitted by a second base station serving said second cell.

9. The method according to claim 8, wherein said information is transmitted via a first base station serving said first cell.

10. The method according to claim 9, wherein said information is transmitted in a radio link failure (RLF) indication message between said second and said first cells, and in a handover report message between said first and said third cells.

11. The method according to claim 10, wherein said second and third cells are the same cell.

12. The method according to claim 1, wherein said information is provided to said first or to said third cells when a time period after a successful handover to said first cell is less than a threshold value T_{Max}.

13. The method according to claim 1, further comprising the steps of:
providing said information to an operation and management (OAM) node in said cellular wireless communication system; and
using said information for collecting statistics about radio resource control (RRC) re-establishment success.

14. The method according to claim 1, wherein said first, said second and said third cells are served by different base stations.

15. The method according to claim 1, wherein a base station serving said first or said third cells uses said information for tuning one or more mobility parameters and/or for providing one or more performance measurements.

16. The method according to claim 1, wherein said cellular wireless communication system is any in the group comprising: LTE, UMTS, CDMA2000, WiMaX and GERAN; said base stations is any is any in the group comprising: eNB, NodeB and BTS; and said mobile station is any in the group comprising: UE, MS and SS.

17. A method in a base station for providing information in a cellular wireless communication system, wherein each cell in said cellular wireless communication system is served by a base station, and said cellular wireless communication system employs a procedure in which a mobile station suffering from a radio link failure (RLF), when being connected to a cell, may attempt to re-establish a connection in another cell, comprising:
receiving a radio resource control (RRC) re-establishment request from said mobile station;
registering a radio link failure (RLF) for said mobile station while connected to a first cell; and
providing information, whether said radio resource control (RRC) re-establishment for said mobile station was successful or not, to said first cell and/or to a third cell, wherein said third cell is the cell to which said mobile station was connected before said first cell.

18. The method in a base station according to claim 17, wherein said step of providing information involves:
transmitting said information to a first base station serving said first cell or to a third base station serving said third cell directly or via one or more X2 and/or S1 interfaces over one or more other base stations in said cellular wireless communication system.

19. A computer program, comprising code means, which when run in a computer causes said computer to execute said method according to claim 17.

20. The computer program product comprising a computer readable medium and a computer program according to claim 19, wherein said computer program is included in the computer readable medium, and consist of one or more from the group: ROM (Read-Only Memory), PROM (Programmable ROM), EPROM (Erasable PROM), Flash memory, EEPROM (Electrically EPROM) and hard disk drive.

21. A base station device for providing information in a cellular wireless communication system, wherein each cell in said cellular wireless communication system is arranged to be served by a base station, and said cellular wireless communication system employs a procedure in which a mobile station suffering from a radio link failure (RLF), when being connected to a cell, may attempt to re-establish a connection in another cell, comprising a processor being configured to:
receive a radio resource control (RRC) re-establishment request from said mobile station;
register a radio link failure (RLF) for said mobile station while connected to a first cell; and
provide information, whether said radio resource control (RRC) re-establishment for said mobile station was successful or not, to said first cell and/or to a third cell, wherein said third cell is the cell to which said mobile station was connected before said first cell.
